(19) United States
(12) Patent Application Publication
(10) Pub. No.: US 2011/0246888 A1
(43) Pub. Date: Oct. 6, 2011

(54) Interactive Electronic Book Device

(76) Inventors: Karen Drucker, Belmont, CA (US); James Baka, Belmont, CA (US)

(21) Appl. No.: 13/161,755

(22) Filed: Jun. 16, 2011

Related U.S. Application Data
(63) Continuation-in-part of application No. 12/397,294, filed on Mar. 3, 2009.

(51) Int. Cl. G06F 3/048; G06F 3/16

(52) U.S. Cl. 715/716

(57) ABSTRACT

An electronic book device is disclosed having: a housing supporting a touch-sensitive display screen; a memory disposed within the housing, the memory including an electronic book application; and a processor disposed within the housing, the processor in electronic communication with the memory and with the touch-sensitive display screen; wherein the electronic book application functions to produce and virtually display the book page in the touch-sensitive display screen, the book page including an interactive region therein, the electronic book application responding to a touch in the interactive region by causing the storing of an audio file in or the retrieving of an audio file from the memory.

### CROSS-REFERENCE TO RELATED APPLICATION

The present application is a continuation-in-part of pending Utility patent application “Interactive Electronic Children's Books” filed 3 Mar. 2009 and assigned filing No. Ser. No. 12/397,294, incorporated herein by reference in its entirety.

### FIELD OF THE INVENTION

This invention pertains generally to electronic books, and more specifically to providing interactive reading for users of electronic books.

### BACKGROUND OF THE INVENTION

In the electronic age in which we live, many toys and entertainment products for children include electronically generated sound and/or video. Such products range from talking and singing teddy bears and other stuffed animals, to toy cars and the like which produce electronically-generated noises, to audio books recorded on media (e.g., audio tape or compact disk) to video games with extensive graphics and sounds tracks.

Although these products can be fun, many of them do not help to develop foundational skills in children, and in some cases actively hinder such development. For example, playing with toys that produce frequent beeps and chirps when handled might condition children to except such instantaneous reactions to real world events. When interactions with people and objects do not produce immediate audiovisual feedback, children accustomed to expect such results might quickly lose interest. Clearly, it is not desirable for children to develop such short attention spans.

Where a parent or caregiver reads a book out loud to a child, the child typically simultaneously views the text and accompanying pictures, thereby actively learning to associate the oral narrative with the written word (not to mention the intimacy that is developed by being read to by a loved one). On the other hand, where the child is plopped down and instructed to listen to a book on tape, the process is a passive one.

Listening to a paid author read a recorded story does not involve the child in the typographic process. Toys and games that include video images can be even more problematic for children. After all, playing a video game or watching a recorded movie is akin to watching television, which, in large doses, is well known to produce short attention spans and passivity in young children.

The potential negative effects notwithstanding, the technology made possible by the ready availability of inexpensive, small electronic components has the potential to be used in ways that positively influence children, and actively develop literacy skills in their native or foreign languages. It would be desirable to address these issues for children and for other users.

### BRIEF SUMMARY OF THE INVENTION

In one aspect of the present invention, an electronic book device suitable for producing and virtually displaying a book page, comprises: a housing supporting a touch-sensitive display screen; a memory disposed within the housing, the memory including an electronic book application; and a processor disposed within the housing, the processor in electronic communication with the memory and with the touch-sensitive display screen; wherein the electronic book application functions to produce and virtually display the book page on the touch-sensitive display screen in a selected language, the book page including an interactive region therein, the electronic book application responding to a touch in the interactive region by causing either the storing of an audio file in the memory or the retrieving of an audio file from the memory.

In another aspect of the present invention, a method suitable for providing interactive reading to a user comprises: displaying a virtual book page in a touch-sensitive display screen of an electronic book device, the virtual book page having an interactive region; reading a text selection provided in the virtual book page, the text selection or embedded audio track on the virtual book page preceding the interactive region, the text selection or embedded audio being provided in either of the native tongue of the user or in a language foreign to the user; and touching the interactive region thereby either executing playback of a previously-recorded audio file generated by the user or enabling the recording of an audio clip spoken by the user in the context of the text selection or challenge question on the virtual book page.

In still another aspect of the present invention, a computer-readable storage medium is disclosed, having embodied thereon a program, the program being executable by a processor to perform a method for providing interactive reading to a user, the method comprising the steps of: displaying a virtual book page in a touch-sensitive display screen of an electronic book device, the virtual book page being provided in either of the native tongue of the user or in a language foreign to the user; providing an interactive region on the book page; and either causing a playback of a previously-recorded audio file or recording an audio clip spoken by the user in response to sensing a touch in the interactive region.

The additional features and advantage of the disclosed invention are set forth in the detailed description which follows, and will be apparent to those skilled in the art from the description or recognized by practicing the invention as described, together with the claims and appended drawings. The features and advantages described are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTIONS OF THE DRAWINGS

FIG. 1 is a diagrammatical illustration of an electronic book device adapted for electronically providing a selected sequence of virtual book pages on a touch-sensitive display screen, in accordance with an aspect of the present invention;

FIG. 2 is a detail view of the virtual book page as may be displayed on the electronic book device of FIG. 1, the book page including a virtual audio entry button;

FIG. 3 is a flow diagram illustrating operation of the electronic book device of FIG. 1;

FIG. 4 is a detail view of the virtual book page of FIG. 2, showing a recording in progress button; and,

FIG. 5 is a detail view of the virtual book page of FIG. 2, showing a recorded audio button, a moose icon, and a squirrel icon.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention discloses an interactive electronic book that allows a user, such as a child, a parent, grandparent, teacher, or care giver, to actively create parts of a story line by supplying inputs at key points in the story and thereby providing an interactive reading experience for the user. In the context of an educational foreign language electronic book, the user would supply audio recordings in the targeted language of the electronic book for later playback to further enhance the learning experience with the sound of one's own voice and improve the probability of long term memory retention. In the context of building elementary math, vocabulary, and spelling skills, the user would supply audio recordings in response to the preceding; text or embedded audio for the corresponding virtual book page. The electronic book can be in the form of an electronic tablet device with an interactive visual display, where the words of the text appear on virtual pages in a display screen. In addition, words of the text or a mathematical challenge question may be provided in either the native tongue of the child or in a language foreign to the child. In this manner, the child may use the disclosed electronic tablet to learn a foreign language.

The interactive electronic book may be implemented on a touch sensitive tablet computing device or touch sensitive smartphone, for example. Pages in the virtual book may be “turned” by swiping a finger (i.e., a digit), from right to left across the touchscreen to advance one page within the book, or from left to right to go back one page in the book. Software in the virtual book application processes the digital signals produced in the touchscreen by the touch gesture and makes a decision as to whether an actual page turn (forward or back) has occurred, thus advancing to the next page or returning to the previous page. For the version of the virtual book implemented on a personal computer, a mouse click in a specified region or virtual buttons on the virtual page will enable a page transition forward or back.

At pre-selected places in the virtual text, a word (or phrase) of the story, a mathematical answer to a formula, the pronunciation of a word, or the spelling of a word, is omitted. An interactive region is provided in place of the answer(s), where the child is prompted to supply a word, the spelling of a word, the math answer, or a phrase which is recorded for subsequent playback. A virtual record button (in the shape of a cloud in this example) is provided in the display screen at the point of the omitted text to control the recording of supplied content. When the electronic book is subsequently re-read, the virtual playback button provided in the display screen may be “pressed” whenever a place in the text is reached at which the user previously supplied the answer(s).

As active participants in a story or learning; exercise, the entire process is augmented by the sound of a child's own voice. Children can essentially become co-authors of stories by steering the narrative. In this scenario, the child will imagine and incorporate his or her own experiences, the names of friends, associates, and family members into the story line. The invention leverages a personal context and the act of hearing one's own voice to increase a child's sensitivity to the sound of language, either native or foreign, thus creating a more meaningful linguistic and literary experience. In the context of reading and math fundamental learning, the child's own voice in response to challenge questions (written or audio) on the virtual page will also increase the probability of long term memory retention.

With a targeted storyline incorporated in the invention, a supplied audio and content drawn out by a child's interaction with the invention can also expose their fears and or traumatic experiences they have witnessed or been subjected to. One skilled in the relevant art of child psychology can apply a targeted narrative in the story, in accordance with the invention, to uncover past incidents of child abuse or trauma. In this application, the invention leads and prompts the child to volunteer relevant information while creating a controlled, indirect, and unthreatening environment for the child to express his or her innermost feelings and fears.

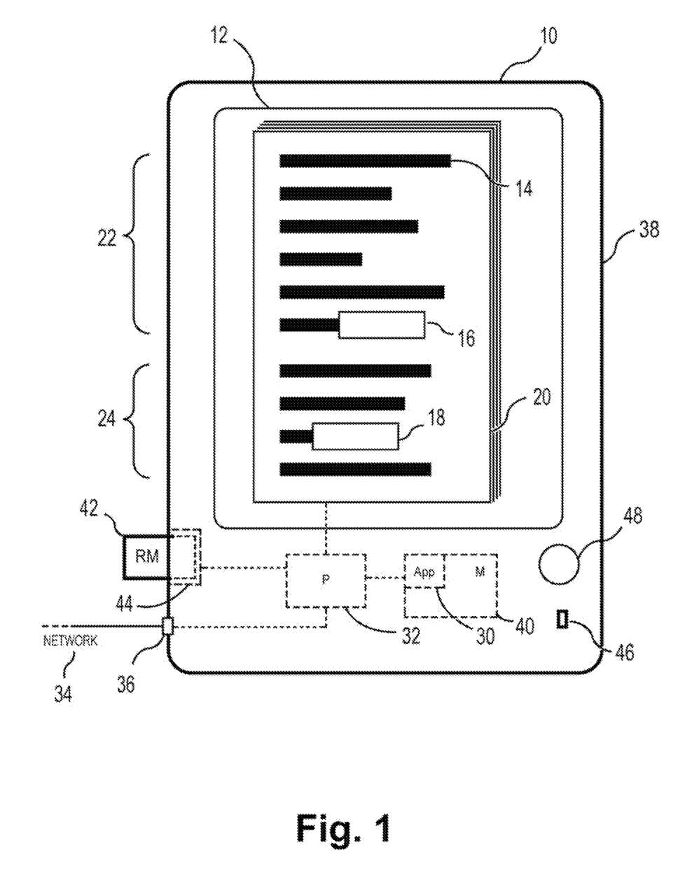

There is shown in FIG. 1 a diagrammatical illustration of an electronic book device 10, adapted for electronically providing a selected sequence of virtual book pages on a touch-sensitive display screen 12, in accordance with an aspect of the present invention. A child or an adult may read text 14 displayed within a virtual book page 20 on the display screen 12. The reader may stop at a first interactive region 16, in a first text selection 22, and at a second interactive region 18, in a second interactive region 24.

One or more words may be missing from the text 14 in the first interactive region 16 and from the second interactive region 18. Accordingly, the child is expected to verbally provide a word or phrase of his or her own choosing at these locations. The child's verbal responses are then retained as audio files in a memory 40 by an electronic book application 30, the audio files linked to the corresponding interactive region for retrieval as desired, as explained in greater detail below.

It is to be understood that the electronic book device 10, according to the present invention, can have numerous and varied titles, storylines, themes and illustrations, and may be provided in a language foreign to the child or other user. The content can be fictional or non-fictional. A series entitled “All about Me,” for example, might be created to parallel various stages of a child's development including, for example: First Day of School, Vacation, Field trip, Going Potty, A Day at the Beach, etc. With content targeted at reading and vocabulary fundamental exercises, and not content comprising a linear narrative storyline, the device and method of the invention can also be applied to building basic reading, speaking, spelling, and foreign language skills where the sound of the child's voice advances and inspires the learning process.

In an exemplary embodiment, the electronic book application 30 is stored in the memory 40 of the electronic book device 10, and is executed by a processor 32. In an alternative embodiment, the electronic book application 30 may be remotely accessed from an external server (not shown) over a network 34, such as the Internet, via a wired or wireless network port 36. This configuration provides a network communication link between a remote server (not shown) and the electronic book application 30. This communication link enables the electronic book application 30 to access and retrieve a previously-stored virtual book or a previously-accessed book reading session, for example, created by the same child or by different children.

In yet another alternative embodiment, the electronic book application 30 may be loaded into the memory 40 of the electronic book device 10 from a removable electronic storage device, such as a memory card 42 inserted into a card slot 44 on a housing 38 supporting the touch-sensitive display screen 12 and enclosing the processor 32 and the memory 40. Accordingly, the processor 32 is in electronic communication with the network port 36, the card slot 44, and the electronic book application 30, as indicated in the illustration. It can be appreciated by one skilled in the relevant art that a user can place the memory card 42 into a computer, a laptop, a netbook, a personal digital assistant, or other such electronic device, and load the electronic book application 30 into the corresponding electronic device.

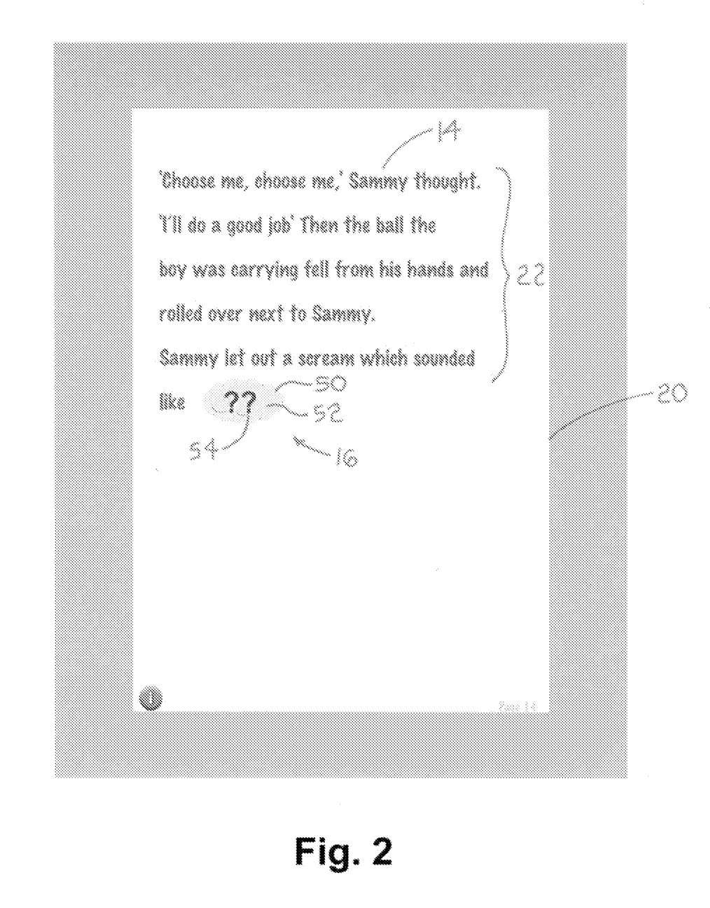

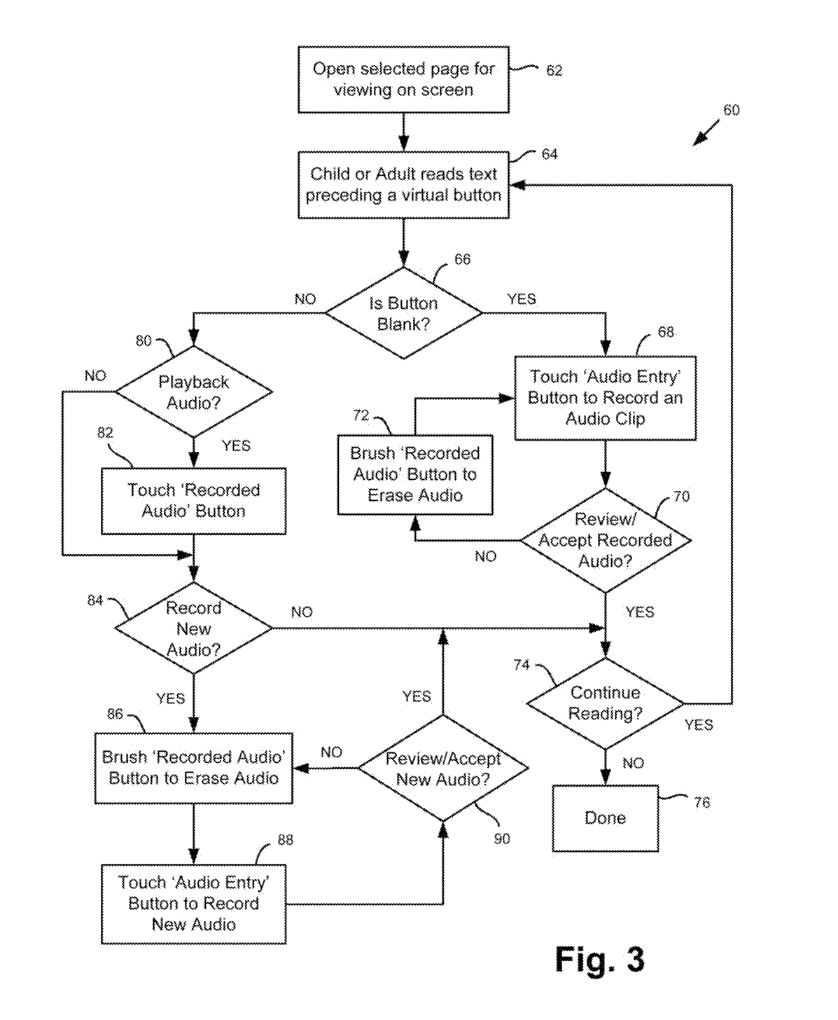

FIG. 2 shows the virtual book page 20 in greater detail with the text selection 24 omitted for clarity of illustration. In this illustration, using English as an example, the first interactive region 16 follows a passage which reads “Sammy let out a scream which sounded . . . ” At this point, the child's own words can be added in context with the narrative of the story. Operation of the electronic book device 10 from this point on may be explained with additional reference to a flow diagram 60, in FIG. 3. The reader powers up the electronic book device 10 to display the virtual book page 20 on the touch-sensitive display screen 12, at step 62. As can be appreciated by one skilled in the relevant art, the book page 20 may be generated on the display screen 12 by a graphics card (not shown) in the electronic book device 10.

The child or adult may read out loud the text selection 22 containing the lines of text 14, in which one or more words are missing at the first interactive region 16. That is, the electronic book application 30 provided in the electronic book application 30 functions to insert the first interactive region 16 in place of the text or words missing, spelling of a word, or answer to a math question in the text selection 22. The electronic book application 30 may display in the first interactive region 16 a “blank” virtual audio entry button 50, here configured as a cloud 52 with question marks 54 in the cloud 52. The virtual audio entry button 50 indicates to the reader that there is no recorded audio file in the memory 40 corresponding to the missing word(s) in the first interactive region 16. The question marks 54 in the pink color of the cloud 52 may indicate to the child or other user that a word or phrase should be supplied to complete the missing portion of the incomplete text selection 22.

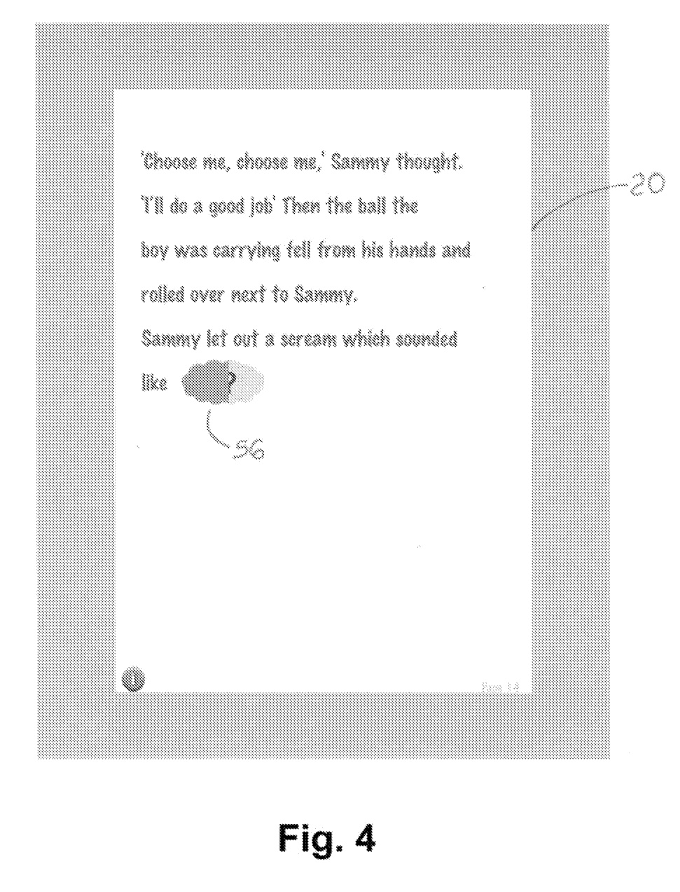

If the pink virtual audio entry button 50 is displayed, at decision block 66, the child can “press and hold” on the virtual audio entry button 50 to begin recording an audio clip by reciting a word or a phrase into a microphone 46, at step 68. The recorded sound can be stored as an audio file in the memory 40 in any known format such as, for example, MP3 or another digital compression format for audio, audio compact disk format, or an analog signal. As the spoken word or phrase is being recorded, the appearance of the virtual audio entry button is modified to indicate that a recording is in process. In an exemplary embodiment, the cloud 52 in the virtual audio entry button 50 may change color and gradually obscure the question marks 54 with a red field filling and movie incrementally across the cloud from left to right, as indicated by a virtual “recording in progress” button 56, shown in FIG. 4.

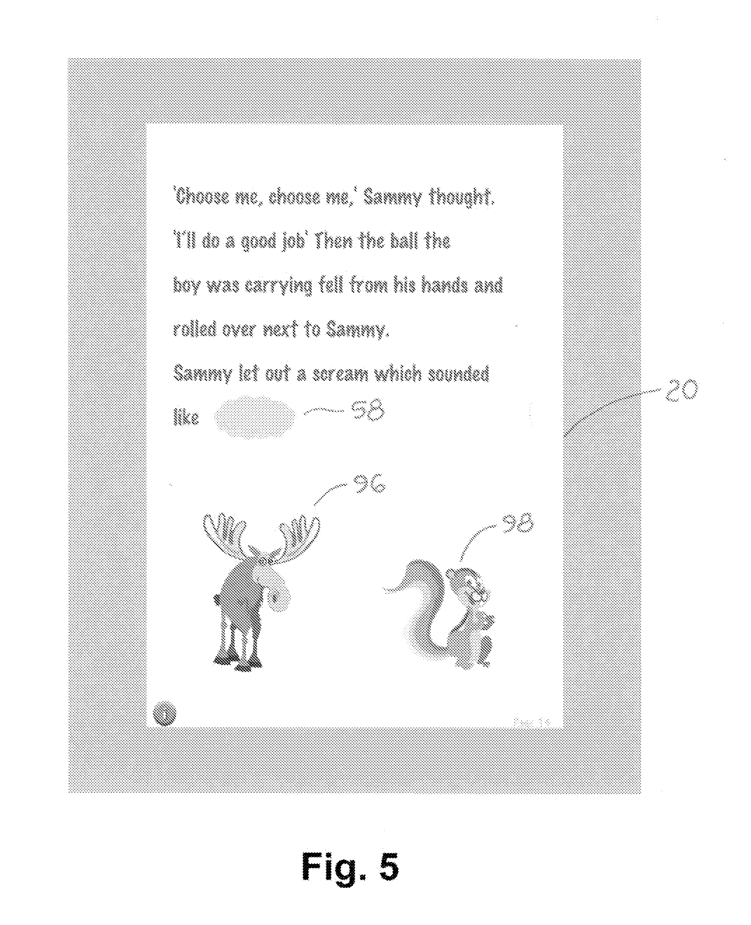

When the child or other user stops pressing on the virtual recording in progress button 56, the recording process ends and the virtual recording in progress button 56 changes physical appearance to a virtual “recorded audio” button 58, such as shown in FIG. 5. In an exemplary embodiment, the virtual recording in progress button 56 may be a color, such as red, that is different from the color of the virtual recorded audio button 58, which may be green.

The user may review the audio clip by momentarily pressing the green recorded audio button 58, thus using a playback speaker 48 provided on the electronic book device 10. If the audio playback is reviewed and found acceptable to the child, at decision block 70, the child and adult may decide to continue reading the virtual book page 20, at decision block 74, and return to step 68, or to end the reading session, at step 76. It can be appreciated by one skilled in the art that the electronic book application 30 provides for both the playback of a previously-recorded audio file as well as the storing of an audio clip spoken by the child or other user as an audio file.

If the audio playback is not acceptable to the child, at decision block 70, the audio clip may be re-recorded, at step 72, by the user sweeping his or her finger in a contiguous up and down touch motion gesture dragging across the virtual recorded audio button 58. That is, the user digitally brushes a finger across the virtual recorded audio button 58, to reverse the context of the virtual recorded audio button 58, thus returning it to its original form and context, as the virtual audio entry button 50. The user may then touch or press the virtual audio entry button 50, at step 68, to record an acceptable audio clip, and then review the current audio clip, at decision block 70.

In an exemplary embodiment, there may also be provided one or more “wiggle” icons on the virtual book page 20, which may be of particular interest to a child. The electronic book application 30 may function to provide one or more “wiggle icons” notify the reader through visual cues, or wiggle movements, or wiggle animations within the virtual page and can be selected/pressed by the child to modify or “morph” the audio being played back. For example, the child may press on a moose icon 96 to trigger the audio playback stored for the corresponding virtual page at a lower the pitch than the original recording. Or, the child may press on a squirrel icon 98 to trigger the audio playback at a higher pitch than the original recording on the page.

In an exemplary embodiment, the parent or child also has an option, via a ‘morph’ wiggle icon (not shown) to modify the previously-recorded audio file upon playback by morphing (i.e., varying or altering) the audio clip upon playback. The additional morphing capabilities include changing the phase characteristics of the audio clip, changing the time domain characteristics of the audio clip, or changing both phase and time-domain characteristics of the audio clip, in addition to altering the pitch characteristics of the audio clip. The child can thus hear, upon playback, his or her original audio recording, but which has been pitch shifted, phase shifted, time-domain shifted, or any combination of these audio alterations.

Alternatively, a ‘multiplex’ wiggle icon can be embedded and used to effect multiplexing the audio playback of a current audio clip, recorded and retrieved by the child or other user, with one of a plurality of audio source files provided in and retrieved from the memory 40. It can be appreciated by one skilled in the relevant art that the microphone 46 facilitates and enables the recording of the audio clip by the child or other user, and the playback speaker 48 facilitates and enables the playback of the audio clip for review and acceptance.

If the audio recording is satisfactory to the user, at step 70, the latest version of the audio file remains in the memory 40 and the user may continue reading, at decision block 74, and return to step 64 to read the next text section 24. Otherwise, the user may complete the reading session, at step 76.

If, at decision block 66, it was determined that the virtual audio entry button 50 was not present, but that the virtual recorded audio button 58 was displayed, as shown in FIG. 4, the user may decide, at decision block 80, whether to play back the audio file. If a playback is desired, the virtual recorded audio button 58 is momentarily touched and the electronic book device 10 plays back the corresponding audio file on the corresponding page via the playback speaker 48. If playback is not desired, the user may decide to record a new audio clip, at decision block 84.

The virtual recorded audio button 58 may be replaced by the virtual audio entry button 50 when the user “digitally brushes” his or her finger in a contiguous motion up and down across the virtual recorded audio button 58, at step 86. This action, performed in the “erasing” motion described above, serves to change the virtual recorded audio button 58 into the virtual audio entry button 50, and also causes erasure of the current audio clip. The new audio clip can be recorded by the user, at step 88, by maintaining a touch or finger pressure on the virtual audio entry button 50, at step 88. If the audio is reviewed, at decision block 90, but not found to be acceptable, the process returns to step 86 where the current audio clip is erased, and a new audio clip is recorded at step 88.

If the current stored audio file is reviewed and found acceptable, at decision block 90, the user may move on to decide if the reading activity will continue, at decision block 74. In an exemplary embodiment, for example, an adult instructor may determine whether a student's pronunciation of a foreign word or phrase was correct, and can be saved. In an alternative embodiment, the recorded audio file may be stored on removable memory, such as an optical medium, a magnetic medium, flash memory, or may be stored in a remote server (not shown). In an exemplary embodiment of the invention, a child or caregiver can record the spelling or pronunciation of a word, and later be challenged by electronic book application 30 to spell or pronounce the word again. The playback of a user's own voice as part of a repetitive use of the electronic book application 30, provides a higher probability of long term memory retention and growth in general literacy competence as auditory and visual cues combine with a personal context.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies, data structures and other aspects are not mandatory or significant, and the mechanisms that implement the invention or its features may have different names, divisions and/or formats. Accordingly, the disclosure of the present invention is intended to be illustrative, but not limiting, of the scope of the invention, which is set forth in the following claims.

It is to be further understood that the description herein is exemplary of the invention only and is intended to provide an overview for the understanding of the nature and character of the invention as it is defined by the claims. The accompanying drawings are included to provide a further understanding of various features and embodiments of the method and apparatus of the invention which, together with their description serve to explain the principles and operation of the invention. Thus, while the invention has been described with reference to particular embodiments, it will be understood that the present invention is by no means limited to the particular constructions and methods herein disclosed and/or shown in the drawings, but also comprises any modifications or equivalents within the scope of the claims.

What is claimed is:

1. An electronic book device suitable for producing and virtually displaying a book page, said electronic book device comprising:
a housing supporting a touch-sensitive display screen;
a memory disposed within said housing, said memory including an electronic book application; and
a processor disposed within said housing, said processor in electronic communication with said memory and with said touch-sensitive display screen;
wherein said electronic book application functions to produce and virtually display the hook page on said touch-sensitive display screen in a selected language, said book page including an interactive region therein, said electronic book application responding to a touch in said interactive region by causing either the storing of an audio file in said memory or the retrieving of a previously-accessed audio file from said memory.

2. The electronic book device of claim 1 further comprising a microphone and a speaker on said housing, said microphone and said speaker both in electronic communication with said processor, said microphone for facilitating recording of said audio file and said speaker for facilitating playback of said audio file.

3. The electronic book device of claim 1 further comprising a card slot suitable for removably retaining an electronic storage device, said card slot in electronic communication with said processor.

4. The electronic book device of claim 1 further comprising a network port for providing a network communication link between a remote server and the electronic book application so as to enable retrieval of a previously-stored virtual book or a previously-accessed virtual book reading session.

5. A method suitable for providing interactive reading to a user, said method comprising the steps of:
displaying a virtual book page in a touch-sensitive display screen of an electronic book device, said virtual book page having an interactive region;
reading a text selection provided in said virtual book page, said text selection preceding said interactive region on said virtual book page, said text selection being provided in either of the native tongue of the user or in a language foreign to the user; and
touching said interactive region thereby either executing playback of a previously-recorded audio file or enabling the recording of an audio clip spoken by the user in the context of the text selection on said virtual book page.

6. The method of claim 5 wherein said step of touching comprises the step of brushing a user's digit up and down across said interactive region, whereby said previously-recorded audio file is erased.

7. The method of claim 5 wherein said interactive region comprises at least one of a virtual audio entry button, a virtual recording in progress button, and a virtual recorded audio button.

8. The method of claim 7 wherein touching said virtual audio entry button enables the user to initiate recording of said audio clip.

9. The method of claim 7 wherein maintaining a touch on said virtual recording in progress button enables the user to continue recording said audio clip.

10. The method of claim 9 wherein said step of maintaining a touch on said virtual recording in progress button modifies the appearance of said virtual recording in progress button.

11. The method of claim 7 wherein pressing said virtual recorded audio hu on enables the user to play back said previously-recorded audio file.

12. The method of claim 7 wherein digitally brushing said virtual recorded audio button with a finger enables the user to initiate erasing said previously-recorded audio file.

13. The method of claim 7 wherein said step of executing playback of said previously-recorded audio file comprises the step of multiplexing, during playback, said previously-recorded audio file with an audio source file stored in memory.

14. The method of claim 7 wherein said step of executing playback of said previously-recorded audio file comprises the step of modifying said previously-recorded audio file by morphing at least one of the pitch, the phase characteristics, or the time domain characteristics of said previously-recorded audio file.

15. A computer-readable storage medium having embodied thereon a program, the program being executable by a processor to perform a method for providing interactive reading to a user, said method comprising the steps of:
displaying a virtual book page including text in a touch-sensitive display screen of an electronic book device, said virtual book page being displayed in either of the native tongue of the user or in a language foreign to the user;
providing an interactive region on said virtual book page; and
in response to sensing a touch in said interactive region, either executing a playback of a previously-recorded audio file or storing as an current audio file an audio clip spoken by the user.

16. The computer-readable storage medium of claim 15 wherein said step of storing said current audio file comprises the step of erasing a previously-recorded audio file.

17. The computer-readable storage medium of claim 15 wherein said step of displaying a virtual book page comprises the step of virtually turning said virtual book page in response to a swiping of a linger on said touch-sensitive display screen.

18. The computer-readable storage medium of claim 15 wherein said step of providing an interactive region on said book page comprises the step of inserting said interactive region in place of one or more words in said text, such that the user is prompted to supply a word or phrase or the spelling of a word in context with a narration of the text.

19. The computer-readable storage medium of claim 15 wherein said step of executing a playback of a previously-recorded audio file comprises the step of modifying said previously-recorded audio file by morphing at least one of the pitch, the phase characteristics, or the time domain characteristics of said previously-recorded audio file.

20. The computer-readable storage medium of claim 15 wherein said step of executing a playback of a previously-recorded audio file comprises the step of multiplexing, during playback, said previously-recorded audio file with an audio source file.
